(19) United States
(12) Patent Application Publication
(10) Pub. No.: US 2015/0243119 A1
(43) Pub. Date: Aug. 27, 2015

(54) PAPER MONEY PROCESSING DEVICE, PAPER MONEY PROCESSING SYSTEM, AND PAPER MONEY CONVEYANCE DEVICE

(71) Applicant: FUJITSU FRONTECH LIMITED, Tokyo (JP)

(72) Inventors: Satoshi HAYASHI, Inagi (JP); Hayato Minamishin, Inagi (JP); Yuji Tanaka, Inagi (JP); Katsuo Takahashi, Inagi (JP); Takashi Wada, Inagi (JP)

(73) Assignee: FUJITSU FRONTECH LIMITED, Tokyo (JP)

(21) Appl. No.: 14/626,017

(22) Filed: Feb. 19, 2015

(30) Foreign Application Priority Data
Feb. 21, 2014 (JP) 2014-032078

(51) Int. Cl. G07D 11/00

(52) U.S. Cl. CPC G07D 11/0018

(57) ABSTRACT

A paper money processing device includes a device conveyance unit that receives a paper money inserted into an input port and feeds the received paper money to a storage cassette in a device housing, and a device conveyance unit that has one end connected to the device conveyance unit and the other end exposed to the outside of the device housing from a supply/collection port upon a paper money supply and a paper money collection.

### CROSS-REFERENCE TO RELATED APPLICATION(S)

This application is based upon and claims the benefit of priority of the prior Japanese Patent Application No. 2014-032078, filed on Feb. 21, 2014, the entire contents of which are incorporated herein by reference.

### FIELD

The embodiments discussed herein are related to a paper money processing device, a paper money processing system, and a paper money conveyance device.

### BACKGROUND

Conventionally, a paper money processing device, such as an automated teller machine (ATM) or a paper money dispenser installed at a bank teller's window, includes a “storage cassette” provided in a housing of the device. When a user deposits cash, the user puts paper moneys into a cash dispensing port, and the put paper moneys are conveyed in the paper money processing device by a conveyance unit in the device to be delivered and stored in the storage cassette. On the other hand, when the user withdraws cash, paper moneys stored in the storage cassette are conveyed in the paper money processing device by the conveyance unit in the device to be discharged from the cash dispensing port. For this, paper moneys are supplied as necessary in the storage cassette to prevent shortage of paper money in a transaction. On the other hand, when the number of paper moneys stored in the storage cassette is too large, the paper moneys are collected as necessary.

Conventionally, a “supply/collection cassette” is sometimes used for the above-mentioned process of supplying paper moneys and the process of collecting paper moneys. The supply/collection cassette is provided to be used in a space same as the space where the storage cassette is provided in the housing of the paper money processing device. Conventional examples are described in Japanese Laid-open Patent Publication No. 2007-293770.

A door provided on the housing of the paper money processing device is always locked to ensure security.

However, in the conventional supply process and the collection process, security is likely to be deteriorated, because the door is unlocked and opened every time the above processes are executed. A security guard entrusted by a bank often carries out the supply process and the collection process, in place of a bank staff, for an automated teller machine installed in a place other than bank branches, such as a convenience store or an ATM corner. In this case, the security guard carries a key given in trust from a bank, so that security cannot sufficiently be ensured.

### SUMMARY

According to an aspect of an embodiment, a paper money processing device includes a device housing; an input port from which a paper money is inserted, the input port communicating an inside and an outside of the device housing with each other; a first device conveyance unit that receives the paper money inserted into the input port and feeds the received paper money to a storage cassette; a supply/collection port through which a paper money passes upon a paper money supply and upon a paper money collection, the supply/collection port communicating an inside and an outside of the device housing with each other; and a second device conveyance unit that has one end connected to the first device conveyance unit and the other end exposed to the outside of the device housing from the supply/collection port upon the paper money supply and the paper money collection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating one example of a paper money processing system according to a first embodiment;

FIG. 2 is a view illustrating one example of a paper money processing device according to the first embodiment;

FIG. 3 is an enlarged view illustrating a second device conveyance path;

FIG. 4 is a view illustrating one example of a loading unit;

FIG. 5 is a view illustrating one example of a loading unit;

FIG. 6 is a view illustrating one example of a paper money conveyance device according to the first embodiment;

FIG. 7 is a view illustrating one example of the paper money conveyance device according to the first embodiment;

FIG. 8 is a view illustrating one example of the paper money conveyance device according to the first embodiment;

FIG. 9 is a view illustrating one example of the paper money conveyance device according to the first embodiment;

FIG. 10 is a view illustrating one example of the paper money conveyance device according to the first embodiment;

FIG. 11 is an explanatory view illustrating a joint part of the device paper money conveyance unit and the paper money conveyance device;

FIG. 12 is a view for describing an example of a configuration of a supply/collection cassette according to the first embodiment;

FIG. 13 is a view for describing an assembly of a paper money processing system;

FIG. 14 is a view for describing an assembly of a paper money processing system;

FIG. 15 is a view for describing a flow of a paper money in a cash deposit mode;

FIG. 16 is a view for describing a flow of a paper money in a paper money supply mode;

FIG. 17 is a view for describing a flow of a paper money in a paper money supply mode;

FIG. 18 is a view for describing a flow of a paper money in a paper money collection mode; and

FIG. 19 is a view for describing a flow of a paper money in a paper money collection mode.

### DESCRIPTION OF EMBODIMENTS

Preferred embodiments of the present invention will be explained with reference to accompanying drawings. The paper money processing device, the paper money processing system, and the paper money conveyance device disclosed in the present application are not limited by the embodiments. In the description below, the paper money processing system is a paper money dispensing device installed at a bank teller's window, for example. However, the paper money processing system is not limited thereto. In the embodiments, the components having the same functions are identified by the same reference numerals, and the redundant description will not be repeated.

### First Embodiment

### Outline of Paper Money Processing System

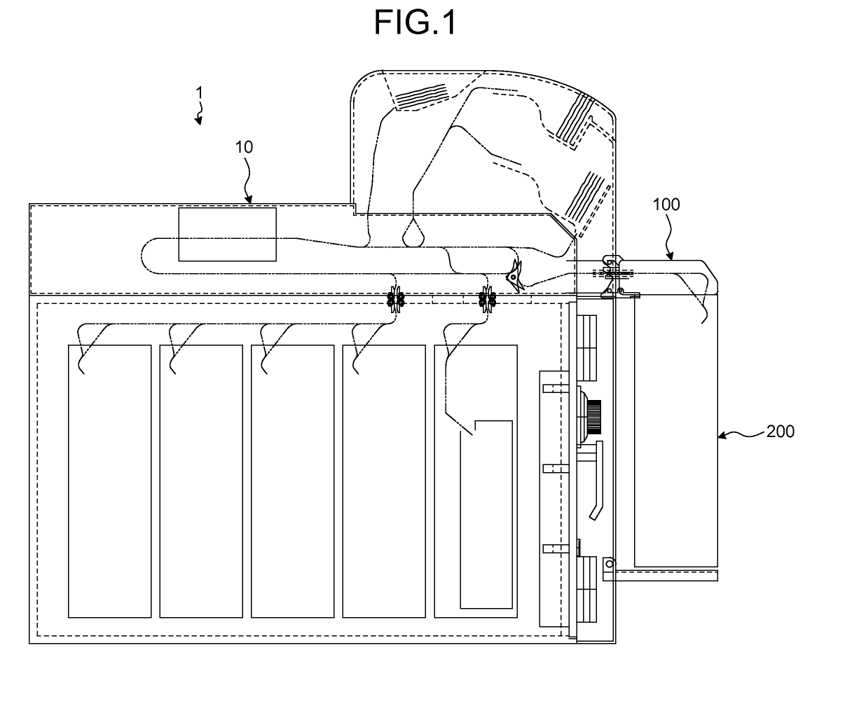

FIG. 1 is a view illustrating one example of a paper money processing system according to the first embodiment. In FIG. 1, a paper money processing system 1 includes a paper money processing device 10, a paper money conveyance device 100, and a supply/collection cassette 200. The right side in FIG. 1 is defined as “front” of the paper money processing device 10, the left side in FIG. 1 is defined as “back” of the paper money processing device 10, the upper side in FIG. 1 is defined as an “upper side” of the paper money processing device 10, and the lower side in FIG. 1 is defined as a “lower side” of the paper money processing device 10.

In FIG. 1, the paper money conveyance device 100 is mounted to a front surface of a housing of the paper money processing device 10. The supply/collection cassette 200 is present below the mounted paper money conveyance device 100 and is placed onto a top surface of a loading unit projecting from the front surface of the housing of the paper money processing device 10. With this configuration, a paper money input/output unit provided on the top surface of the supply/collection cassette 200 and a conveyance unit of the paper money conveyance device 100 are connected to each other, whereby paper moneys can be exchanged between the supply/collection cassette 200 and the paper money conveyance device 100.

As described above, the paper money processing device 10, the paper money conveyance device 100, and the supply/collection cassette 200 are connected in the paper money processing system 1. Thus, upon supplying paper moneys, the paper moneys stored in the supply/collection cassette 200 are conveyed to the paper money processing device 10 via the paper money conveyance device 100, and upon collecting paper moneys, the paper moneys accumulated in the paper money processing device 10 are conveyed to the supply/collection cassette 200 via the paper money conveyance device 100.

As described above, a supply process and a collection process of paper moneys can be carried out with the paper money conveyance device 100 and the supply/collection cassette 200, which are mounted outside the housing of the paper money processing device 10. This configuration can reduce a risk of security deterioration of the paper money processing device 10.

Example of Configuration of Paper Money Processing Device

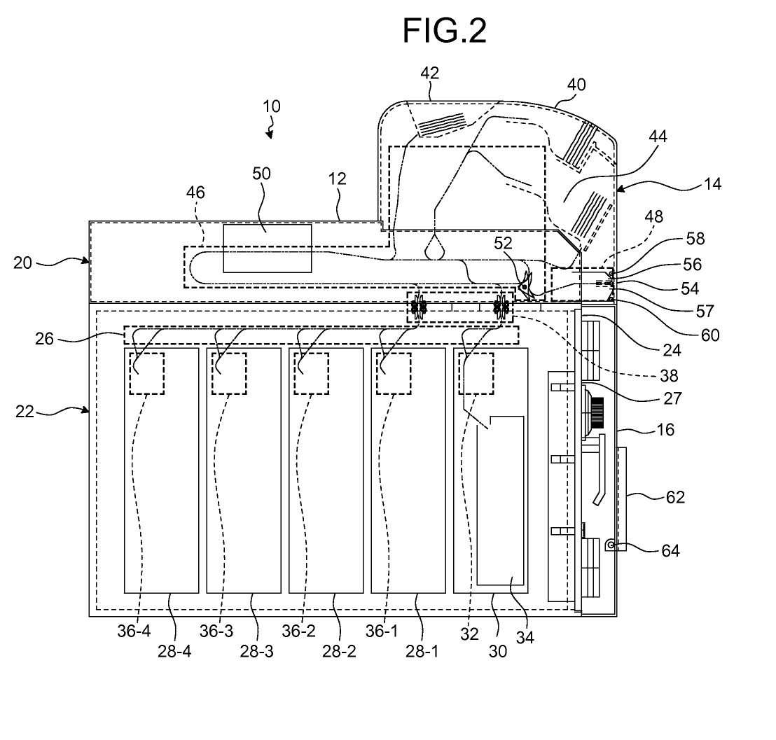

FIG. 2 is a view illustrating one example of the paper money processing device according to the first embodiment. FIG. 2 is a transparent view schematically illustrating a configuration of the paper money processing device 10 viewed from the left side.

In FIG. 2, a control unit (not illustrated) for controlling the whole paper money processing device 10 and a paper money processing unit 14 that performs a paper money deposit process and a paper money payment process according to a control of the control unit are housed in a device housing 12 of the paper money processing device 10. A door 16 that can be locked is provided on a front surface of the device housing 12.

The paper money processing unit 14 includes an upper unit 20 and a lower unit 22.

The lower unit 22 includes a box-like safe housing 24. The safe housing 24 includes a safe conveyance unit 26. The safe conveyance unit 26 includes various types of conveyance path forming members including conveyance guides and rollers. The various types of conveyance path forming members form a conveyance path (hereinafter sometimes referred to as a “safe conveyance path”). A door 27 that can be locked is provided on a front surface of the safe housing 24.

The safe housing 24 includes four storage cassettes 28-1 to 28-4 storing received paper moneys and paper moneys to be delivered, and a reject cassette 30 storing “rejected paper moneys” therein. The “rejected paper money” means a defective paper money such as a damaged paper money or folded paper money. The storage cassettes 28 and the reject cassette 30 have the same configuration, for example. Specifically, each cassette functions as the storage cassette 28 or the reject cassette 30 depending on the place where the cassette is mounted. The cassette mounted at the most front part in the safe housing 24 is the reject cassette 30. The storage cassettes 28 and the reject cassette 30 are mounted detachable from the safe housing 24. Specifically, the storage cassettes 28 and the reject cassette 30 are exposed to the outside of the device housing 12 by drawing a drawer case (not illustrated) on which the storage cassettes 28 and the reject cassette 30 are placed with the doors 16 and 27 being unlocked and opened. Thus, a bank staff can easily load or unload the storage cassettes 28 and the reject cassette 30, for example.

The reject cassette 30 includes a reject cassette conveyance unit 32 provided on its top end, the reject cassette conveyance unit 32 having plural types of conveyance path forming members including conveyance guides and rollers. Specifically, the plural types of conveyance path forming members form a conveyance path (hereinafter sometimes referred to as a “reject cassette conveyance path”) in the reject cassette conveyance unit 32.

The reject cassette conveyance unit 32 introduces therein a rejected paper money conveyed by the safe conveyance unit 26 and stores the introduced paper money into a storage space 34.

Each of the storage cassettes 28 includes a storage cassette conveyance unit 36 provided on its top end, the storage cassette conveyance unit 36 having plural types of conveyance path forming members including conveyance guides, rollers, and drive motors. Specifically, the plural types of conveyance path forming members form a conveyance path (hereinafter sometimes referred to as a “storage cassette conveyance path”) in the storage cassette conveyance unit 36.

The storage cassette conveyance unit 36 introduces therein a paper money conveyed by the safe conveyance unit 26, and stores the introduced paper money into a storage space (not illustrated) in the storage cassette 28. The storage cassette conveyance unit 36 also extracts a paper money stored in the storage cassette 28, and feeds the extracted paper money to the safe conveyance unit 26. The safe conveyance unit 26 is connected to a later-described device conveyance unit 46 via a delivery unit 38.

The upper unit 20 includes an input port 42 from which a paper money is inserted and an output port 40 from which a paper money is extracted, the input port 42 and the output port 40 being provided on an upper end of the upper unit 20. The upper unit 20 also includes a temporary storage unit 44 temporarily storing a paper money and device conveyance units 46 and 48.

The device conveyance unit 46 is connected to the input port 42, the output port 40, the temporary storage unit 44, and the delivery unit 38. The device conveyance unit 46 has plural types of conveyance path forming members including conveyance guides, rollers, drive motors, and a route changeover gate. The plural types of conveyance path forming members form a conveyance path (hereinafter sometimes referred to as a “first device conveyance path”). The device conveyance unit 46 conveys, one by one, paper moneys inserted into the input port 42 to the temporary storage unit 44 via a validation unit 50, and feeds one by one the paper moneys stored in the temporary storage unit 44 to the safe conveyance unit 26 via the delivery unit 38.

The upper unit 20 includes the validation unit 50 that validates a paper money conveyed by the device conveyance unit 46. The validation unit 50 validates whether a conveyed paper money is an authentic paper money or a rejected paper money. An authentic paper money is stored in any one of the storage cassettes 28-1 to 28-4 via the device conveyance unit 46, the delivery unit 38, and the safe conveyance unit 26, while a rejected paper money is conveyed to the reject cassette 30 via the device conveyance unit 46, the delivery unit 38, and the safe conveyance unit 26 and stored therein.

The upper unit 20 also includes a gate 52 that switches a connection state between the device conveyance unit 46 and the device conveyance unit 48, the gate 52 being provided between the device conveyance unit 46 and the device conveyance unit 48. For example, the gate 52 separates the device conveyance unit 46 from the device conveyance unit 48 upon storing paper moneys and upon extracting paper moneys. On the other hand, the gate 52 connects the device conveyance unit 46 and the device conveyance unit 48 upon supplying paper moneys and upon collecting paper moneys.

The device conveyance unit 48 has plural types of conveyance path forming members including conveyance guides, rollers, and gears. The plural types of conveyance path forming members form a conveyance path (hereinafter sometimes referred to as a “second device conveyance path”). One end of the second device conveyance path can be exposed to the outside of the device via a supply/collection port 54 that communicates the inside and the outside of the device with each other on the front surface of the device housing 12.

Comb-like connection portions 56 and 57 are provided at one end of the second device conveyance path. The connection portions 56 and 57 are meshed with later-described connection portions in the paper money conveyance device 100, whereby the second device conveyance path and the conveyance path in the paper money conveyance device 100 are connected to each other.

Shafts 58 and 60 are mounted respectively at an upper part and a lower part of one end of the second device conveyance path near the supply/collection port 54. A hook of the paper money conveyance device 100 is hooked on the shaft 58, and a pawl of a lock lever of the paper money conveyance device 100 is hooked on the shaft 60. With this configuration, the paper money processing device 10 and the paper money conveyance device 100 are connected to each other.

An attachment detection sensor (not illustrated) is provided in the vicinity of the supply/collection port 54. When the paper money conveyance device 100 is attached to the paper money processing device 10, the attachment detection sensor outputs a detection signal to the control unit described above. When receiving the detection signal, the control unit switches the mode of the paper money processing device 10 to the supply/collection mode. Specifically, the control unit controls the gate 52 to connect the first device conveyance path and the second device conveyance path to each other. With this connection, paper moneys can be exchanged between the paper money processing device 10 and the supply/collection cassette 200 that is loaded on a loading unit 62 described later.

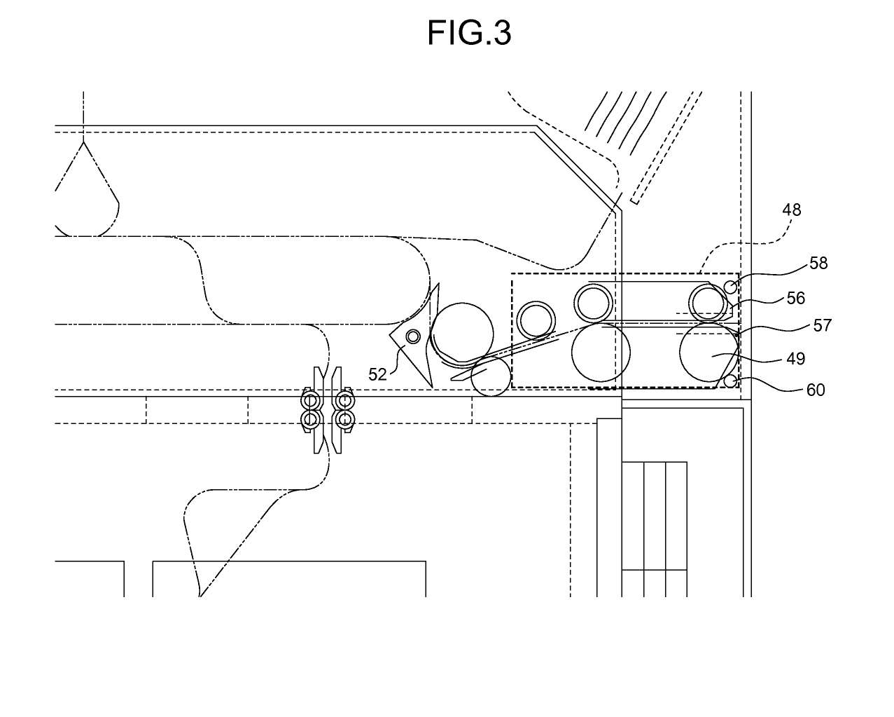

FIG. 3 is a view illustrating an enlarged portion of the second device conveyance path. As illustrated in FIG. 3, the device conveyance unit 48 includes a gear unit 49. This gear unit 49 can be meshed with a gear unit in the paper money conveyance device 100 to transmit driving force, used for conveyance of paper moneys in the device conveyance unit 48, to the paper money conveyance device 100. Thus, the paper money conveyance device 100 can convey paper moneys by using the driving force transmitted from the gear unit 49 without receiving an electric supply.

Returning to FIG. 2, the above-mentioned loading unit 62 is provided on the front surface of the device housing 12. The loading unit 62 has a sheet-like shape, for example. One end of the loading unit 62 is fixed by a shaft 64, and the loading unit 62 is configured to be openable by being rotated about the shaft 64 serving as a rotating shaft.

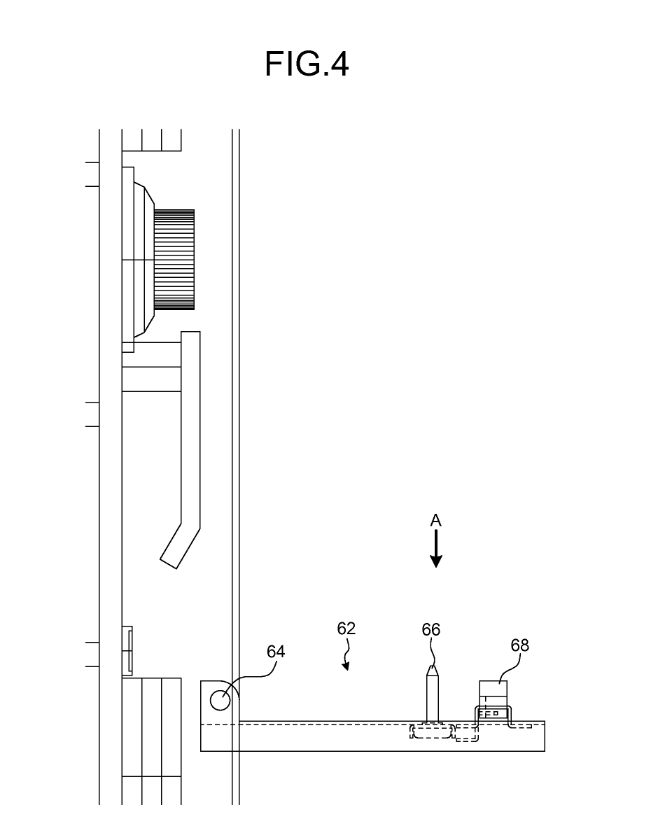

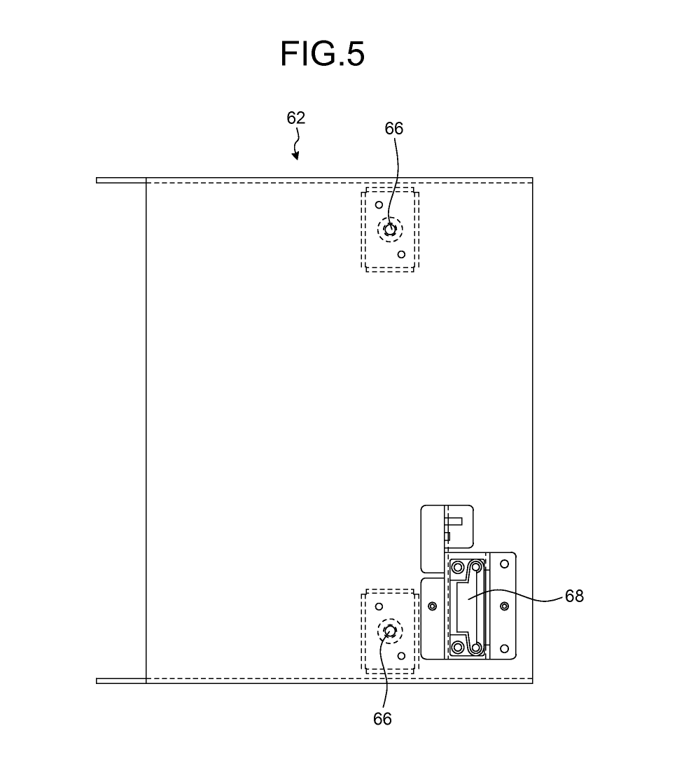

FIGS. 4 and 5 are views illustrating one example of the loading unit. FIG. 4 is a view illustrating the loading unit viewed from left, and FIG. 5 is a view illustrating the loading unit from a direction of an arrow A in FIG. 4, i.e., from top.

As illustrated in FIGS. 4 and 5, stationary pins 66 projecting from a loading surface are provided on the loading surface of the loading unit 62. Each of the stationary pins 66 is provided on a left end and on a right end of the loading unit 62. The stationary pins 66 are inserted into holes formed on the lower surface of the supply/collection cassette 200, when the supply/collection cassette 200 is loaded on the loading surface. Specifically, the stationary pins 66 are used as positioning pins for specifying the loading position of the supply/collection cassette 200.

A power supply terminal 68 is provided on the loading surface of the loading unit 62. When the supply/collection cassette 200 is loaded on the loading surface, the power supply terminal 68 is electrically connected to a terminal provided on the lower surface of the supply/collection cassette 200. With this connection, the loading unit 62 can receive electric power supplied from the paper money processing device 10 via the power supply terminal 68, whereby the supply/collection cassette 200 can drive a drive motor and the like of the supply/collection cassette 200.

Example of Configuration of Paper Money Conveyance Device

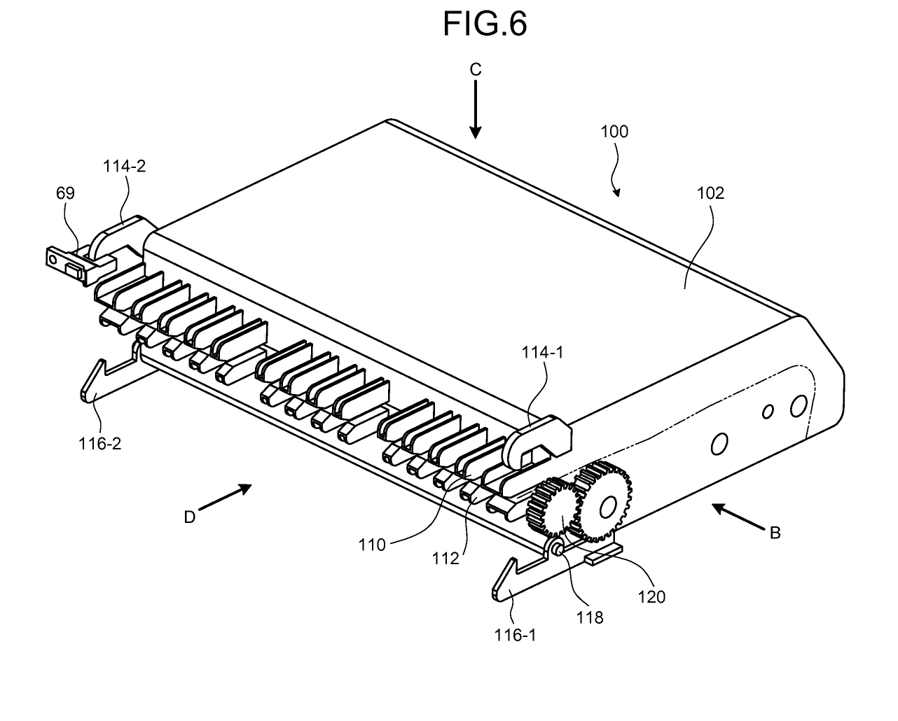

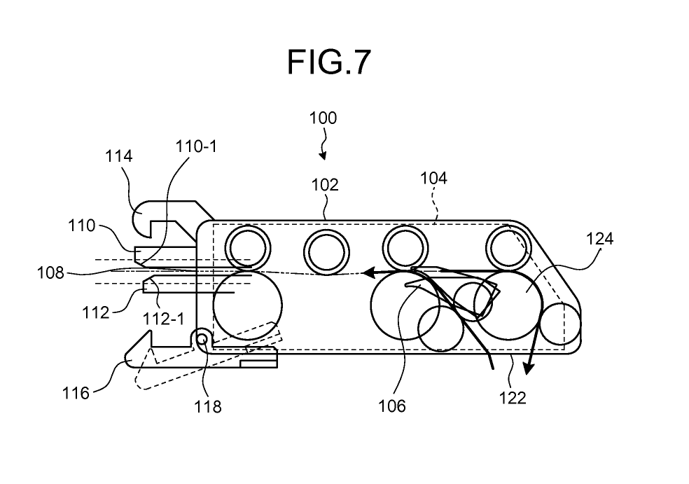

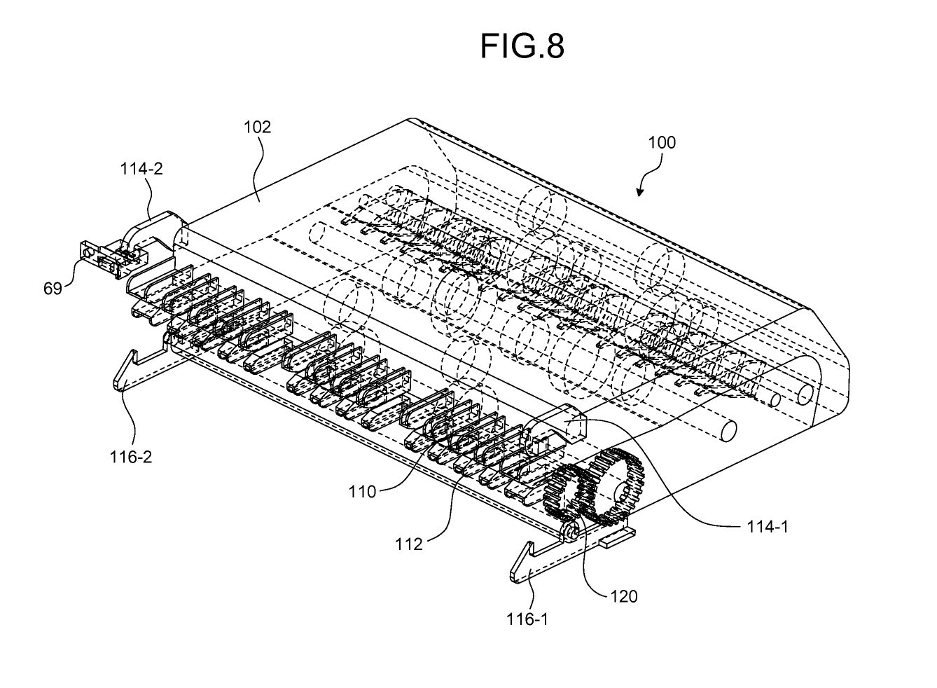

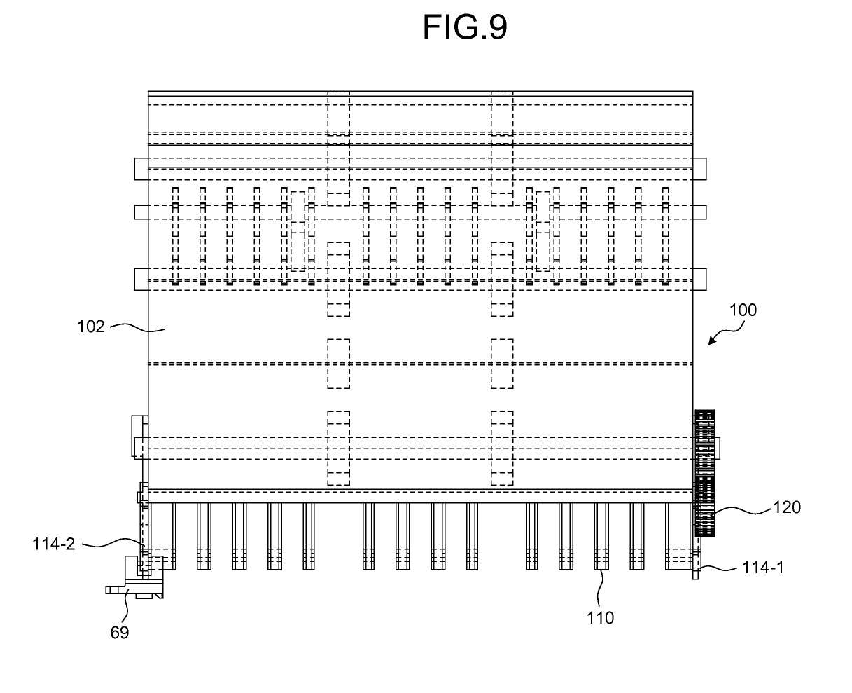

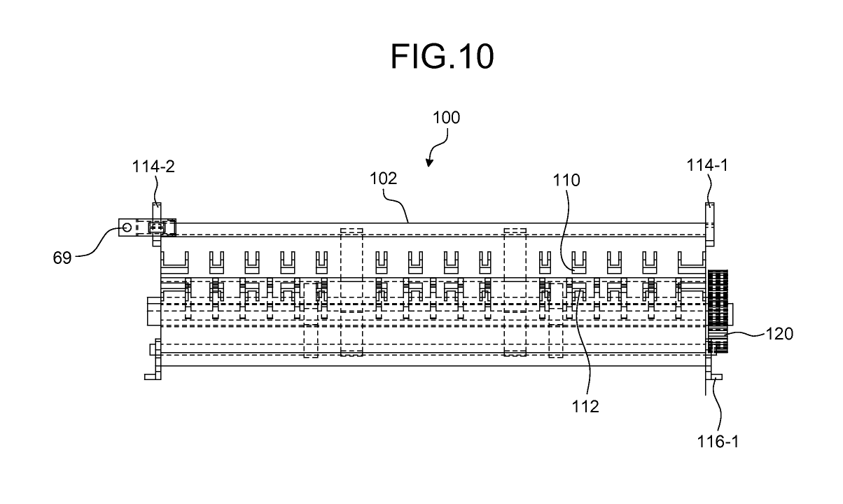

FIGS. 6 to 10 are views illustrating one example of the paper money conveyance device according to the first embodiment. FIG. 6 is a perspective view of the paper money conveyance device 100. FIG. 7 is a transparent view schematically illustrating the configuration of the paper money conveyance device 100 viewed from left, i.e., from a direction of an arrow B in FIG. 6. FIG. 8 is a transparent view schematically illustrating the configuration of the paper money conveyance device 100 in FIG. 6. FIG. 9 is a transparent view schematically illustrating the configuration of the paper money conveyance device 100 viewed from top, i.e., from a direction of an arrow C in FIG. 6. FIG. 10 is a view schematically illustrating the configuration of the paper money conveyance device 100 viewed from back, i.e., from a direction of an arrow D I FIG. 6. FIG. 6 also illustrates an attachment detection sensor 69 of the paper money processing device 10 for the sake of convenience.

The paper money conveyance device 100 includes a device housing 102. The device housing 102 has a conveyance unit 104. The conveyance unit 104 has plural types of conveyance path forming members including conveyance guides, rollers, and a route changeover gate 106, and these plural types of the conveyance path forming members form a conveyance path.

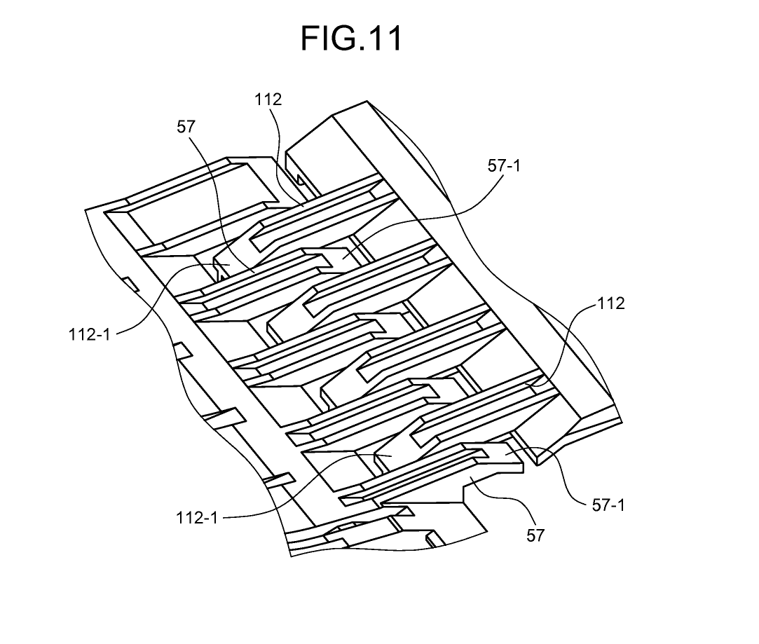

Comb-like connection portions 110 and 112 are provided on an upper part and on a lower part of an opening 108 of the conveyance path at the back surface of the paper money conveyance device 100. Each of the connection portions 110 and 112 has plural tooth portions. The tooth portions of each of the connection portions 110 and 112 are provided to project from the back surface of the device housing 102. The distance between the opposing surfaces of the tooth portion of the connection portion 110 and the tooth portion of the connection portion 112 increases toward the tip end of each tooth portion at the tip end. Specifically, a space formed between two opposing surfaces of the tooth portion of the connection portion 110 and the tooth portion of the connection portion 112 has a tapered shape. In other words, the tooth portions of the connection portions 110 and 112 have taper shapes (taper portions) 110-1 and 112-1 at their tip ends. As illustrated in FIG. 11, tooth portions of the connection portions 56 and 57 in the paper money processing device 10 also have taper shapes (for example, a taper shape 57-1) similar to the tooth portions of the connection portions 110 and 112. The connection portions 56 and 57 and the connection portions 110 and 112 are meshed with each other, whereby a part where a paper money is likely to be stuck in the conveyance direction of the paper money in the conveyance path at the joint part can be reduced. FIG. 11 is an explanatory view illustrating the joint part between the device conveyance unit 48 and the paper money conveyance device 100.

Hooks 114-1 and 114-2 are respectively provided at an upper left end and an upper right end of the device housing 102. As described above, the hooks 114-1 and 114-2 are hooked on the shaft 58 in the paper money processing device 10.

Lock levers 116-1 and 116-2 are respectively provided at a lower left end and a lower right end of the device housing 102. Each of the lock levers 116-1 and 116-2 is supported about a shaft 118, and is rotatable about the shaft 118 serving as a rotation shaft. As described above, each of the lock levers 116-1 and 116-2 is hooked on the shaft 60.

A gear unit 120 is provided on a left surface and a right surface of the device housing 102 at its rear end. The gear unit 120 is connected to the conveyance unit 104 via a shaft. The gear unit 120 is meshed with the gear unit 49 in the paper money processing device 10, when the paper money processing device 10 and the paper money conveyance device 100 are connected to each other. Thus, the gear unit 120 can transmit driving force, which is used for the conveyance of a paper money in the device conveyance unit 48, to the conveyance unit 104.

An opening 122 of the conveyance path in the paper money conveyance device 100 is formed on the lower surface of the device housing 102. The opening 122 faces an inlet/outlet port for a paper money provided on the top surface of the supply/collection cassette 200, when the supply/collection cassette 200 is loaded on the loading unit 62. Thus, a paper money can be exchanged between the conveyance unit 104 and the supply/collection cassette 200.

The conveyance path in the conveyance unit 104 has a first route passing through the upper side and front side of a roller 124 (right side in FIG. 7) and a second route passing through a back side (left side in FIG. 7) of the roller 124. The leading end of the route changeover gate 106 is biased downward to basically close the second route. Therefore, a paper money conveyed from the opening 108 to the opening 122 is conveyed to the supply/collection cassette 200 through the first route. On the other hand, a paper money fed from the supply/collection cassette 200 to the conveyance unit 104 via the opening 122 is conveyed through the second route in the conveyance unit 104 by pushing up the route changeover gate 106.

Example of Configuration of Supply/Collection Cassette

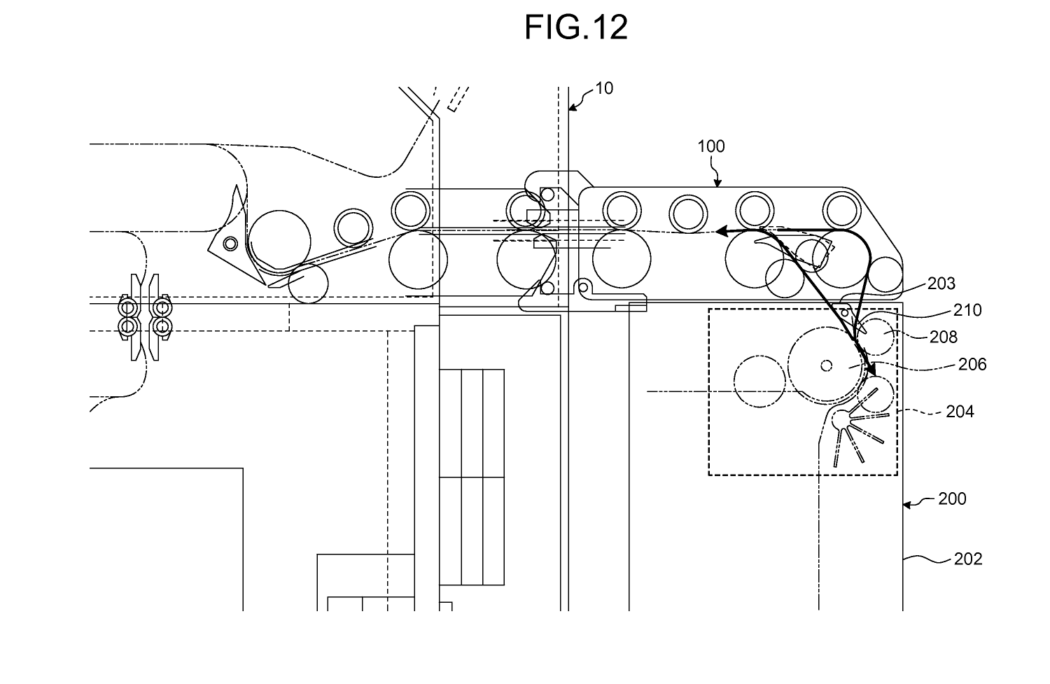

FIG. 12 is a view for describing an example of a configuration of the supply/collection cassette according to the first embodiment. FIG. 12 schematically illustrates the configuration when the supply/collection cassette is viewed through its top end. For the sake of convenience, FIG. 12 also illustrates a part of the paper money processing device 10 and the paper money conveyance device 100 connected to the paper money processing device 10. The supply/collection cassette 200 basically has the configuration same as the storage cassette 28. Therefore, one type of cassette can be used for both the storage cassette and the supply/collection cassette.

The supply/collection cassette 200 has a cassette housing 202. An inlet/outlet port 203 is formed on the top surface of the cassette housing 202, the inlet/outlet port 203 being an opening into which a paper money is inserted and from which a paper money is extracted. As described above, the inlet/outlet port 203 faces the opening 122 of the paper money conveyance device 100, when the supply/collection cassette 200 is loaded on the loading unit 62. Thus, paper moneys can be exchanged between the paper money conveyance device 100 and the supply/collection cassette 200.

The supply/collection cassette 200 has, on its top end, a supply/collection cassette conveyance unit 204 including plural types of conveyance path forming members having conveyance guides, rollers, and drive motors. Specifically, the plural types of conveyance path forming members form a conveyance path (hereinafter sometimes referred to as a “supply/collection cassette conveyance path”) in the supply/collection cassette conveyance unit 204.

For example, the supply/collection cassette conveyance unit 204 includes rollers 206 and 208, and a route changeover gate 210. The supply/collection cassette conveyance path has a first route passing through a front side of the route changeover gate 210, i.e., passing between the route changeover gate 210 and the roller 208, and a second route passing through a back side of the route changeover gate 210, i.e., passing between the route changeover gate 210 and the roller 206. The leading end of the route changeover gate 210 is biased upward to basically close the first route. Accordingly, a paper money entering from the inlet/outlet port 203 upon the process of collecting the paper money pushes down the leading end of the route changeover gate 210, and is stored in the storage space in the supply/collection cassette 200 through the first route. On the other hand, a paper money fed from the storage space upon the process of supplying the paper money is fed to the paper money conveyance device 100 through the second route. The paper money passing through the first route in the paper money conveyance device 100 passes through the first route in the supply/collection cassette 200, and the paper money fed to the paper money conveyance device 100 through the second route in the supply/collection cassette 200 passes through the second route in the paper money conveyance device 100. Specifically, the first route in the supply/collection cassette 200 is connected to the first route in the paper money conveyance device 100, and the second route in the supply/collection cassette 200 is connected to the second route in the paper money conveyance device 100.

Example of Operation of Paper Money Processing System

An example of an operation of the paper money processing system 1 having the above configuration will be described.

Assembly Step

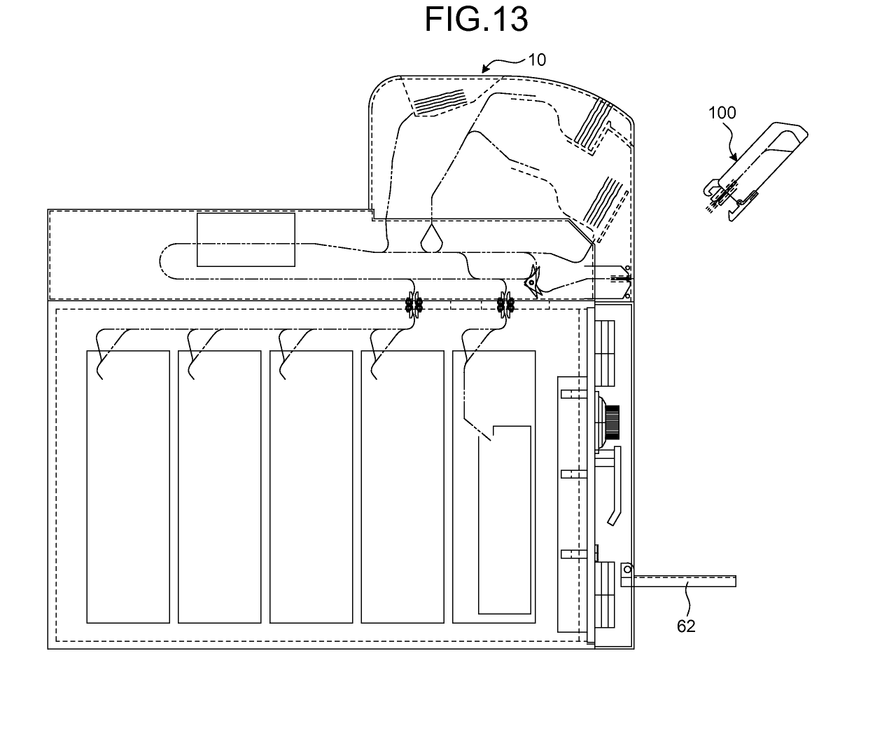

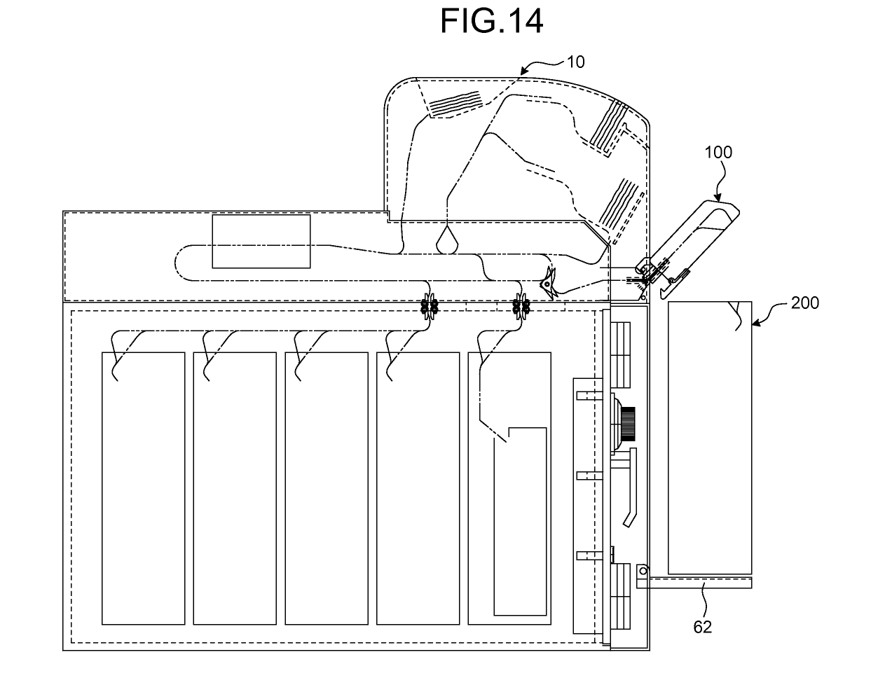

An assembly step of the paper money processing system 1 will firstly be described. The assembly step is carried out by a staff (e.g., a bank staff or a security guard) upon supplying paper moneys or collecting paper moneys. FIGS. 13 and 14 are views for describing the assembly of the paper money processing system.

The paper money processing device 10 is basically used alone during a financial transaction. Therefore, the paper money conveyance device 100 is not attached to the paper money processing device 10 as illustrated in FIG. 2. Upon supplying paper moneys or collecting paper moneys, a staff firstly draws the loading unit 62 to bring the loading unit 62 into a loadable state (see FIG. 13) from a storage state (see FIG. 2).

The supply/collection cassette 200 is loaded on the top surface of the loading unit 62 that is in the loadable state, and the paper money conveyance device 100 is attached to the front surface of the paper money processing device 10, as illustrated in FIG. 14. In this case, the attachment detection sensor 69 detects that the paper money conveyance device 100 is attached, and the control unit described above switches the operation mode of the paper money processing system 1 to the supply/collection mode. For example, the above control unit controls the gate 52 to connect the first device conveyance path and the second conveyance path to each other.

Flow of Paper Money

A flow of a paper money in each operation mode will be described next.

Upon Deposit Mode (Upon Paper Money Input Mode)

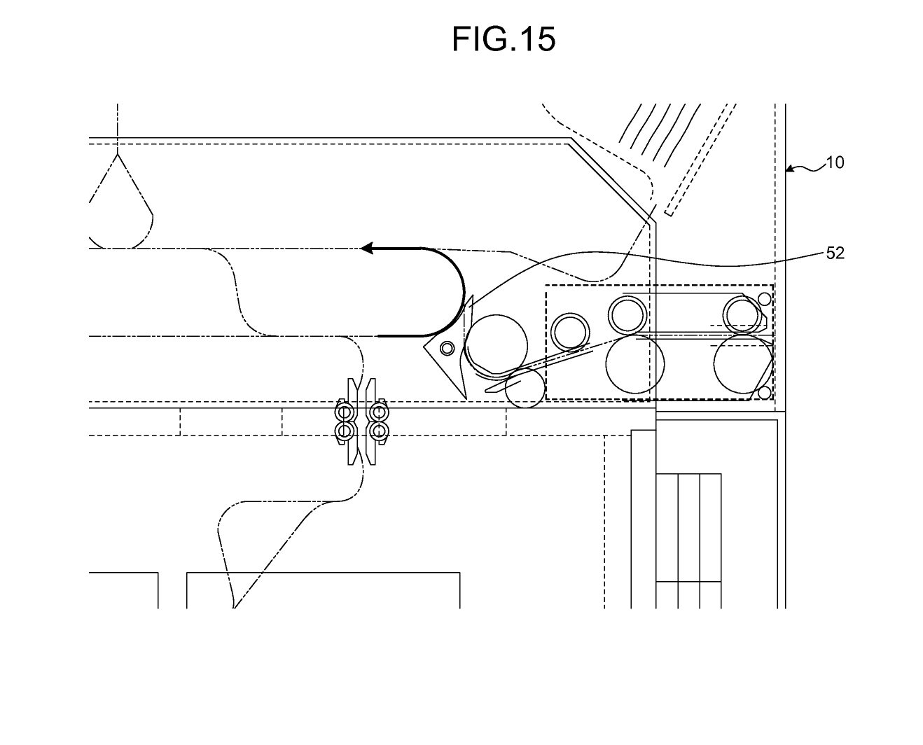

FIG. 15 is a view for describing a flow of a paper money upon a deposit mode. FIG. 15 is an enlarged view of an upper front portion of the paper money processing device.

An arrow in FIG. 15 indicates a flow of a paper money in the deposit mode. Specifically, in the deposit mode, the first device conveyance unit and the second device conveyance unit are separated from each other by the gate 52, whereby a paper money is conveyed by the first device conveyance unit without passing through the second device conveyance unit.

Upon Paper Money Supply Mode

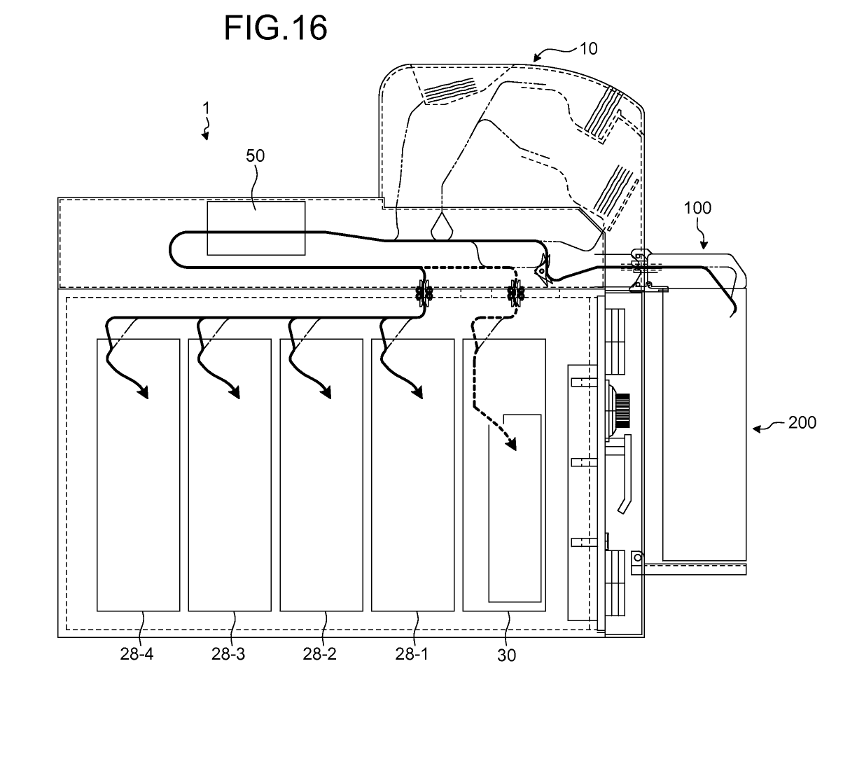

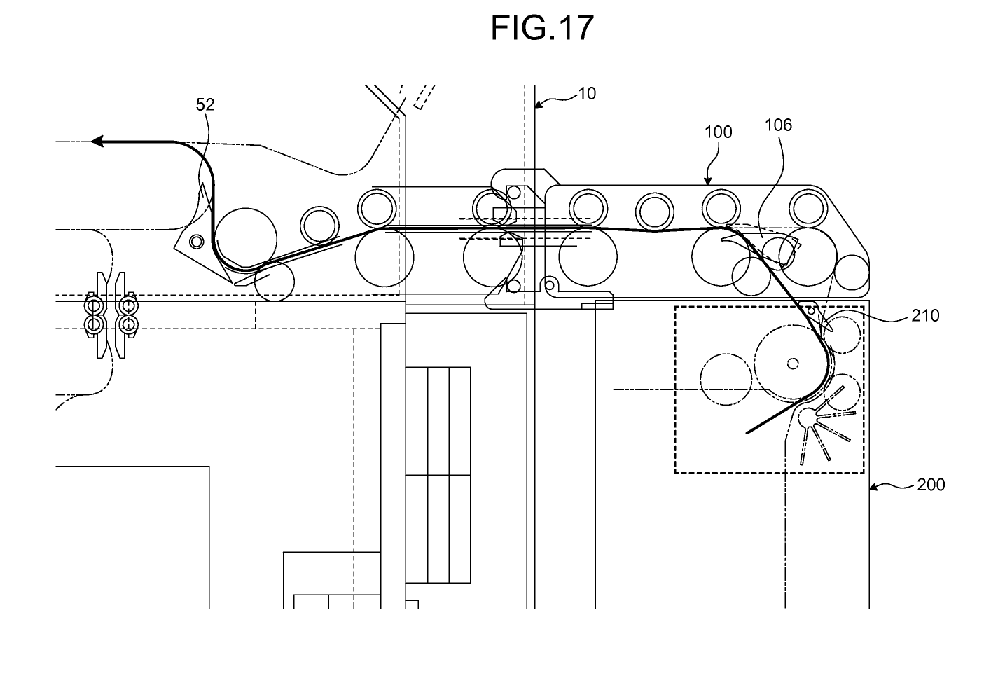

FIGS. 16 and 17 are views for describing a flow of a paper money upon a paper money supply mode. FIG. 16 illustrates the entire paper money processing system 1. FIG. 17 illustrates an enlarged joint part of the paper money processing device 10, the paper money conveyance device 100, and the supply/collection cassette 200.

Arrows in FIGS. 16 and 17 indicate a flow of a paper money in the paper money supply mode. Specifically, a paper money to be supplied passes through the second route in the supply/collection cassette 200, passes through the second route in the paper money conveyance device 100 by pushing up the leading end of the route changeover gate 106, passes through the second device conveyance path in the paper money processing device 10, and is supplied to the first device conveyance path. The paper money supplied to the first device conveyance path is validated by the validation unit 50. When the paper money is authentic, it is conveyed to the storage cassette 28, and when the paper money is a rejected paper money, it is conveyed to the reject cassette 30.

Paper Money Collection Mode

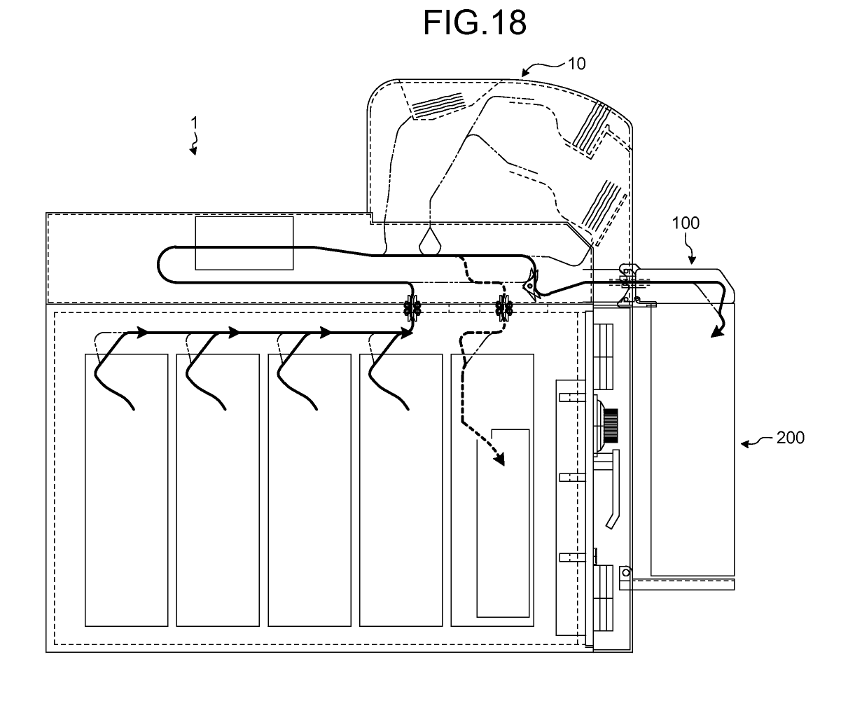

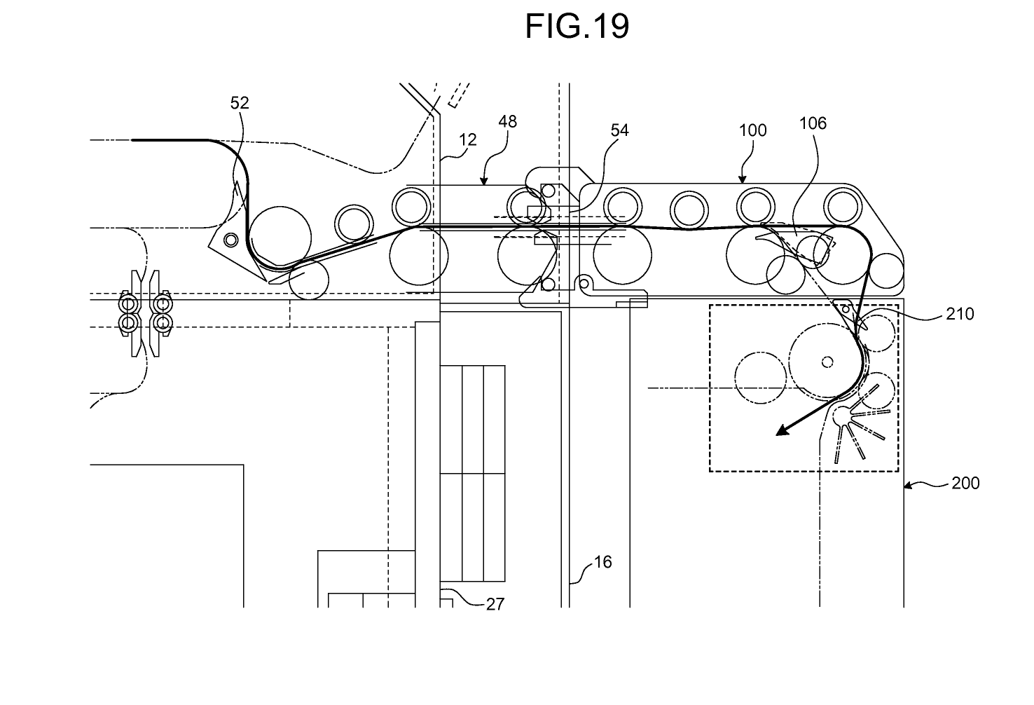

FIGS. 18 and 19 are views for describing a flow of a paper money in the paper money collection mode. FIG. 18 illustrates the entire paper money processing system 1. FIG. 19 illustrates an enlarged joint part of the paper money processing device 10, the paper money conveyance device 100, and the supply/collection cassette 200.

Arrows in FIGS. 18 and 19 indicate a flow of a paper money in the paper money collection mode. Specifically, a paper money to be collected is fed to the first device conveyance path from the storage cassette 28. The paper money fed to the first device conveyance path is validated by the validation unit 50. When the paper money is authentic, it is fed to the second device conveyance path from the first device conveyance path. When the paper money is a rejected paper money, it is conveyed to the reject cassette 30. The paper money fed to the second device conveyance path from the first device conveyance path passes through the first route of the route changeover gate 106 in the paper money conveyance device 100, passes through the first route in the supply/collection cassette 200 by pushing down the leading end of the route changeover gate 210, and is stored in the storage space in the supply/collection cassette 200.

As described above, according to the present embodiment, the paper money processing device 10 includes the device conveyance unit 48 one end of which is connected to the device conveyance unit 46 and the other end thereof is exposed to the outside of the device housing 12 from the supply/collection port 54, upon supplying paper moneys and upon collecting paper moneys.

According to the configuration of the paper money processing device 10, paper moneys can be supplied to the storage cassette 28 in the paper money processing device 10 and can be collected from the storage cassette 28, via the supply/collection port 54 and the device conveyance unit 48. Accordingly, paper moneys can be supplied and collected without opening the doors 16 and 27, whereby a risk of security deterioration can be reduced.

The paper money processing device 10 also includes the gate 52 that switches the connection state between the device conveyance unit 46 and the device conveyance unit 48. Specifically, the gate 52 separates the device conveyance unit 46 and the device conveyance unit 48 from each other upon storing paper moneys inserted into the input port 42, and connects the device conveyance unit 46 and the device conveyance unit 48 to each other upon supplying and collecting paper moneys.

According to this configuration of the paper money processing device 10, the device conveyance unit 46 can be used in both the paper money storing process, as well as the paper money supplying process and the paper money collecting process. Specifically, this configuration can avoid the increase in size of the paper money processing device 10.

The paper money processing device 10 also includes the connection portions 56 and 57 that connect the external paper money conveyance device 100, which is detachable to the device conveyance unit 48 from the outside of the device housing 12 via the supply/collection port 54, to the device conveyance unit 48. The connection portions 56 and 57 have a comb-like shape. The distance between the opposing surfaces of the tooth portion of the connection portion 56 and the tooth portion of the connection portion 57 increases toward the tip end of each tooth portion at the tip end of each tooth portion.

This configuration of the paper money processing device 10 can reduce a portion where a paper money is likely to be stuck in the conveyance direction of the paper money on the conveyance path at the joint part between the paper money processing device 10 and the paper money conveyance device 100, when the connection portions 56 and 57 are meshed with the connection portions in the paper money conveyance device 100.

The paper money processing device 10 also includes the gear unit 49 that transmits driving force used for the conveyance of a paper money in the device conveyance unit 48 to the paper money conveyance device 100.

According to this configuration of the paper money processing device 10, the paper money conveyance device 100 can convey a paper money with the driving force transmitted from the paper money processing device 10 without receiving an electric power supply.

The paper money processing device 10 also includes the loading unit 62 that projects outside the device housing 12 from the front surface of the device housing 12. The loading unit 62 has a sheet-like shape, and one end thereof is fixed by the shaft 64. Therefore, the loading unit 62 is configured to be openable by being rotated about the shaft 64 serving as the rotation shaft.

According to this configuration of the paper money processing device 10, the loading unit 62 can be housed in the case other than the paper money supply process or the collection process. Therefore, this configuration can prevent the loading unit 62 from hindering the action of the user using the paper money processing device 10.

The stationary pins 66 are mounted on the top surface of the loading unit 62, wherein the stationary pins 66 are inserted into the holes formed on the lower surface of the paper money conveyance device 100 when the paper money conveyance device 100 is loaded.

According to this configuration of the paper money processing device 10, the paper money conveyance device 100 can easily be loaded on the position where the paper money conveyance device 100 is desired to be loaded.

The power supply terminal 68 is mounted on the top surface of the loading unit 62.

According to this configuration of the paper money processing device 10, electric power can be supplied from the paper money processing device 10 to the paper money conveyance device 100 only by loading the paper money conveyance device 100 on the loading unit 62.

The paper money conveyance device 100 includes the gear unit 120 and the conveyance unit 104. The driving force used for the conveyance of a paper money in the paper money processing device 10 is transmitted to the gear unit 120. The conveyance unit 104 conveys a paper money by using the driving force transmitted to the gear unit 120. The conveyance unit 104 receives a paper money from the supply/collection cassette 200 outside the device housing 12 and supplies the received paper money to the device conveyance unit 48 in the paper money processing device 10 upon the paper money supply process, while it receives a paper money from the device conveyance unit 48 and supplies the received paper money to the supply/collection cassette 200 upon the paper money collection process.

According to this configuration of the paper money conveyance device 100, the paper money conveyance device 100 can convey a paper money with the driving force transmitted from the paper money processing device 10 without receiving an electric supply.

The paper money conveyance device 100 is configured to be mountable to the paper money processing device 10 from the outside of the device housing 12 via the supply/collection port 54 formed on the device housing 12 of the paper money processing device 10.

According to this configuration of the paper money conveyance device 100, the paper money conveyance device 100 can be detached from the paper money processing device 10 during the period other than the paper money supply process or the paper money collection process. Accordingly, this configuration can prevent the paper money conveyance device 100 from hindering the action of the user using the paper money processing device 10.

### Other Embodiments

[1] In the first embodiment, it is assumed that the paper money conveyance device 100 is detachable to the paper money processing device 10. However, it is not limited thereto. For example, the paper money processing device 10 may have one end supported by a shaft of the paper money conveyance device 100 to be rotatable about this shaft serving as a rotation shaft, as in the loading unit 62 described above.

[2] In the first embodiment, it is assumed that the loading unit 62 has one end supported by the shaft 64, and the loading unit 62 is openable by being rotated about the shaft 64 serving as a rotation shaft. However, it is not limited thereto. For example, the loading unit 62 may be configured to be detachable to the paper money processing device 10, as in the paper money conveyance device 100.

[3] In the first embodiment, it is assumed that the paper money conveyance device 100 and the supply/collection cassette 200 are mounted on the front surface of the paper money processing device 10. However, it is not limited thereto. For example, the paper money conveyance device 100 and the supply/collection cassette 200 may be mounted on the back surface of the paper money processing device 10. In this case, the supply/collection port 54, the shafts 58 and 60, and the device conveyance unit 48 are provided on the back surface of the paper money processing device 10.

[4] In the first embodiment, it is assumed that the paper money conveyance device 100 and the supply/collection cassette 200 are used only for the supply process and the collection process. However, it is not limited thereto. For example, the paper money conveyance device 100 and the supply/collection cassette 200 can be used upon payment of cash. Specifically, a mode for using the supply/collection cassette 200 as an external storage cassette may be prepared. This configuration can expand the paper money processing device 10 only in a peak period, for example.

According to the embodiments discussed herein, a risk of security deterioration during supply and collection of paper moneys can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A paper money processing device comprising:
a device housing;
an input port from which a paper money is inserted, the input port communicating an inside and an outside of the device housing with each other;
a first device conveyance unit that receives the paper money inserted into the input port and feeds the received paper money to a storage cassette;
a supply/collection port through which a paper money passes upon a paper money supply and upon a paper money collection, the supply/collection port communicating an inside and an outside of the device housing with each other; and
a second device conveyance unit that has one end connected to the first device conveyance unit and the other end exposed to the outside of the device housing from the supply/collection port upon the paper money supply and the paper money collection.

2. The paper money processing device according to claim 1, further comprising:
a gate that switches a connection state between the first device conveyance unit and the second device conveyance unit, the gate separating the first device conveyance unit and the second device conveyance unit from each other upon storing the inserted paper money, and connecting the first device conveyance unit and the second device conveyance unit to each other upon the paper money supply and the paper money collection.

3. The paper money processing device according to claim 1, further comprising:
a comb-like connection portion that connects an external conveyance device, which is configured to be detachable to the second device conveyance unit from the outside of the device housing via the supply/collection port, to the second device conveyance unit.

4. The paper money processing device according to claim 3, further comprising:
a drive unit that outputs driving force used for conveying a paper money; and
a power transmission unit that transmits the outputted driving force to the external conveyance device.

5. The paper money processing device according to claim 3, further comprising:
a loading unit on which a supply/collection cassette is loaded, the loading unit projecting outside the device housing.

6. The paper money processing device according to claim 5, wherein the loading unit includes a power supply unit that is provided on a loading surface for supplying electric power supplied from the device housing to the supply/collection cassette.

7. A paper money processing system comprising:
a paper money processing device including:
a device housing;
an input port from which a paper money is inserted, the input port communicating an inside and an outside of the device housing with each other;
a storage cassette that is provided in the device housing, the storage cassette receiving the paper money inserted into the input port through the first device conveyance unit and storing the received paper money;
a supply/collection port through which a paper money passes upon a paper money supply and upon a paper money collection, the supply/collection port communicating an inside and an outside of the device housing with each other; and
a second device conveyance unit that has one end connected to the first device conveyance unit and the other end exposed to the outside of the device housing from the supply/collection port upon the paper money supply and the paper money collection, and
a paper money conveyance device configured to be detachable to the second device conveyance unit from the outside of the device housing via the supply/collection port, the paper money conveyance device receiving a paper money from a supply/collection cassette outside the device housing and feeding the received paper money to the second device conveyance unit upon the paper money supply, while the paper money conveyance device receiving a paper money from the second device conveyance unit and feeding the received paper money to the supply/collection cassette upon the paper money collection.

8. A paper money conveyance device that is an external paper money conveyance device used as being connected to a paper money processing device from an outside of a device housing of the paper money processing device via a supply/collection port provided on the device housing, the paper money conveyance device comprising:
a gear unit to which driving force used for conveying a paper money in the paper money processing device is transmitted; and
a conveyance unit that conveys a paper money with the driving force transmitted to the gear unit, the conveyance unit receiving a paper money from a supply/collection cassette outside the device housing and feeding the received paper money to a device conveyance unit in the paper money processing device upon a paper money supply, while the conveyance unit receiving a paper money from the device conveyance unit and feeding the received paper money to the supply/collection cassette upon a paper money collection.
